(19) United States
(12) Patent Application Publication
(10) Pub. No.: US 2005/0008751 A1
(43) Pub. Date: Jan. 13, 2005

(54) Fermented milk product

(75) Inventors: Rene Draaisma, Vlaardingen (NL); Mettina Maria Koning, Vlaardingen (NL); Adrianus Marinus Ledeboer, Vlaardingen (NL); Elisabeth Claire Leigh-Firbank, Vlaardingen (NL); Christianus Jacobus Van Platerink, Vlaardingen (NL); Johannes Schalk, Vlaardingen (NL)

Correspondence Address: UNILEVER;PATENT DEPARTMENT, 45 RIVER ROAD, EDGEWATER, NJ, 07020, US

(73) Assignee: Unilever Bestfoods, North America

(21) Appl. No.: 10/910,512

(22) Filed: Aug. 3, 2004

Related U.S. Application Data
(62) Division of application No. 10/093,558, filed on Mar. 8, 2002.

(30) Foreign Application Priority Data
Mar. 9, 2001 (EP) 01200916.3

(51) Int. Cl. A23C 9/12

(52) U.S. Cl. 426/583

(57) ABSTRACT

A Fermented milk product is described having an ACE inhibitory effect of at least 35 U/ml, wherein the milk product is produced from milk fermented with Lactobacillus delbrueckii subsp. lactis. Further a food product is described comprising an amount of 0.003 mg/g protein, or more a peptide or peptide salt having 2-15 amino acids, comprising the peptide sequence Asp-Lys and/or Ile-His-Pro-Phe.

### FIELD OF THE INVENTION

The present invention relates to a fermented milk product having a hypertension lowering effect.

### BACKGROUND TO THE INVENTION

Hypertension is very common in the western society. In the year 1999, in the USA more than 25% of the people have above normal blood pressure, caused by the western lifestyle. Hypertension is considered to be one of the main causes of cardiovascular hearth disease (CHD).

Long term human studies have shown that regular intake of low amounts of hypertension lowering drugs reduces CHD with 25% (Gerstein et al. (2000), The Lancet 355, 253-259).

An individual's blood pressure varies throughout the day and there is usually an early morning surge (Khoury, A. F., Sunderajan, P., and Kaplan, N. M., (1992), American Journal of Hypertension, 5, 339-344. This surge in blood pressure corresponds with data, which shows that the early morning is also associated with a prevalence of all cardiovascular catastrophes compared to the remainder of the day (Cannon, E. P., McCabe, C. H., Stone, P. H., et al (1997), American Journal of Cardiology, 79, 253-258 et al. 1997). Abrupt increases in heart rate and platelet aggregation along with other physiological factors are also likely to be involved.

Angiotensin I converting enzyme (ACE) plays a key physiological role in the regulation of several endogenous bio-active peptides and is among others associated with the renin-angiotensin system which regulates blood pressure by the production of the vasoconstrictor peptide angiotensin II and the inactivation of the vasodilator bradykinin (Ondetti, M. A. and Cushman, D. W. (1982), Annu. Rev. Biochem. 51, 283-308). Inhibition of ACE therefore mainly results in an anti-hypertensive effect and most of the hypertension lowering drugs are based on this.

Several naturally occurring peptides have the ability to inhibit ACE and ACE inhibitors like certain snake venom derived peptides and synthetic peptides are known to be able to revert the hypertension.

Recently it has become clear that common food proteins actually may be precursors of many biologically active peptides that are inactive within the protein but may be liberated by enzymatic proteolysis (Meisel, H. and Bockelmann, W. (1999), A. van Leeuwenhoek 76, 207-215). Many peptides, that were able to inhibit ACE, could be isolated from milk proteins (Yamamoto, N and Takano, T. (1999), Nahrung 43, 159-164) or other food proteins (Yamamoto, N. (1997), Biopolymers 43, 129-134). These functional peptides can be accumulated in the food product by enzymatic conversion or by fermentation with specific food grade microorganisms such as lactic acid bacteria. Depending on the length of the peptide, potentially between 15 and 50 mg/g protein can be obtained.

However, only in a few cases, it actually has been shown that after digestion the ACE inhibiting peptides do lower the hypertension in spontaneously hypertensive rats (Yamamoto, N., Akino, A. and Takano, T. (1994), Biosci. Biotech. Bioch., 58, 776-778) and Nakamura, Y., Yamamoto, N., Sakai, K. and Takano, T. (1995), J. Dairy Sci. 78, 1253-1257). One study was done with hypertensive human volunteers (Hata, Y. et al, Am. J. Clin. Nutr 64, 767-771). It was shown that in hypertensive patients that were given this milk daily during 8 weeks, the systolic and diastolic blood pressure was reduced with 5 - 10%, a reduction that lasted for at least 4 weeks after the end of the study. In all studies, the only microorganism that could generate peptides from milk that also had a hypertension lowering effect upon digestion was Lactobacillus helveticus. More specifically it was shown that the milk-derived peptides that were most active in the reduction of hypertension are Val-Pro-Pro from β-casein and Ile-Pro-Pro from β-casein and κ-casein. These peptides could be cleaved from the caseins only by fermentation with Lb. helveticus (Nakamura et al. (1995), J. Dairy Sci. 78, 777-783).

A milk which is fermented with Lactobacillus helveticus and Saccharmomyces cervisiae is commercially available through Calpis, Japan.

Milk, fermented with Lactobacillus helveticus has a number of undesirable properties, such as a low pH as a result of extensive production of lactate and an acidic, not acceptable taste for a large group of consumers.

Moreover, when milk fermented with Lb. helveticus, or whey thereof is used as an ingredient in food products, e.g. in a spread, the acid taste of such food products may be unacceptable.

Other microrganisms than Lb. helveticus have been reported to produce peptides in milk, which give ACE-inhibition. For instance, in a recent publication of Gobetti et al., data on ACE-inhibiting peptides, produced by Lb. delbrueckii subsp. bulgaricus and Lactococcus lactis subsp. cremoris, were presented. However, no data on anti-hypertensive activities of these peptides were presented (Gobetti, M., Feranti, P., Smacchi, E., Goffredi, F. and Addeo, F. (2000), Appl. Env. Microbiol. 66, 3898-3904).

### SUMMARY OF THE INVENTION

It is an object of the invention to provide a fermented milk product that has a pH of 4.2 or higher. Another object of the invention is to provide a fermented milk product that significantly reduces ACE. Another object of the invention is to provide a fermented milk product that has anti-hypertensive activity.

One or more, of these objects is attained according to the invention in that the milk product is fermented with Lactobacillus delbruecki subsp. lactis and that during fermentation microorganisms producing high amounts of lactic acid are substantially absent.

We have screened a large number of lactic acid bacteria, including Lb. delbrueckii subsp. lactis strains, for the production of peptides that significantly reduce ACE and have anti-hypertensive activity. Surprisingly we have found that Lb. delbrueckii subsp. lactis significantly reduces ACE and has anti-hypertensive activity.

Preferably the Lb. delbrueckii subsp. lactis used according to the invention is a Lb. delbrueckii subsp. lactis, that after 24 hours of fermentation at 37° C. in skimmed milk (Yopper ex Campina, Netherlands) gives a pH of the fermented milk of 4.0 or higher, preferably 4.2 or higher and more preferably 4.5 or higher.

The invention further relates to a food product comprising an amount of 0.003 mg/g protein, or more, of a peptide or peptide salt comprising the peptide sequence Asp-Lys and/or Ile-His-Pro-Phe.

The invention further relates to a food product comprising an amount of 0.003 mg/g protein, or more, of the peptide Val-Pro, and/or one or more peptides or peptide salts comprising a peptide sequence selected from the group consisting of Val-Leu-Pro, Leu-Pro-Val-Pro, Leu-Pro-Val, Leu-Pro, Lys-Val-Leu-Pro-Val-Pro, and Lys-Val-Leu-Pro-Val-Pro-Gln.

### DETAILED DESCRIPTION OF THE INVENTION

The amounts given will be expressed, in wt.% or weight parts per million (ppm), mg/kg or g/kg, relative to the total weight of the food product or fermented milk product. Lactobacillus is herein abbreviated as Lb.

Fermented milk products according to the invention are defined as products in which fermented milk was used as an ingredient in an effective amount, such that a noticeable ACE-inhibitory effect is obtained.

Milk fermented with Lactobacillus delbruecki subsp. lactis may herein be abbreviated as lactis fermented milk.

ACE inhibitory effect is herein defined as measured according to the method described in the examples.

Preferably the fermented milk products according to the invention have an ACE inhibitory effect of at least 35%, more preferably at least 50%.

The fermented milk products according to the invention may be of any food type. Preferably the fermented milk products are dairy type products or frozen confectionary products. These preferred types of products are described in some detail below.
Dairy type products

Examples of dairy products according to the invention are milk, dairy spreads, cream cheese, milk type drinks and yoghurt, wherein the milk solids are partly or fully consisting of solids from lactis fermented milk.

An example of a composition for a yoghurt type product is about 50-80 wt. % water, 3-12 wt. % lactis fermented milk solids, 0-15 wt. % whey powder, 0-15 wt. % sugar (e.g. sucrose), 0.01-1 wt. % yoghurt culture, 0-15 wt. % fruit, 0.05-0.5 wt. % vitamins and minerals, 0-2 wt. % flavour, 0-5 wt. % stabilizer (thickener or gelling agent).

A typical serving size for a yoghurt type product could be from 50 to 250 g, generally from 80 to 200 g.
Frozen Confectionery Products

For the purpose of the invention the term frozen confectionery product includes milk containing frozen confections such as ice-cream, frozen yoghurt, sherbet, sorbet, ice milk and frozen custard, water-ices, granitas and frozen fruit purees.

Preferably the level of solids in the frozen confection (e.g. sugar, fat, flavouring etc) is more than 3 wt. %, more preferred from 10 to 70 wt. %, for example 40 to 70 wt. %.

Ice cream will typically comprise 0 to 20 wt. % of fat, 2 to 20 wt. % fermented milk solids, sweeteners, 0 to 10 wt. % of non-fat milk components and optional components such as emulsifiers, stabilisers, preservatives, flavouring ingredients, vitamins, minerals, etc, the balance being water. Typically ice cream will be aerated e.g. to an overrun of 20 to 400 %, more specific 40 to 200 % and frozen to a temperature of from -2 to -200 ° C., more specific -10 to -30 ° C. Ice cream normally comprises calcium at a level of about 0.1 wt %.

Other food product according to the invention can be prepared by the skilled person based on common general knowledge, using fermented milk or fermented milk derived products as an ingredient in suitable amounts. Examples of such food products are baked goods, dairy type foods, snacks, etc.

The pH of the fermented milk product according to the invention is preferably 4.2 or higher, more preferably 4.5 or higher, most preferably 5.0 or higher. Due to the more neutral pH, compared to prior art fermented milk, the taste of the fermented milk products according to the invention is better.

The lactis fermented milk may be used as such as a food product. Alternatively parts of the lactis fermented milk may be used in the preparation of a food product. For example, milk powder or other milk solids, whey and other milk fractions may be used.

Preferably the food product is a whey containing food product in which the whey is produced from milk fermented with Lactobacillus delbrueckii subsp. lactis.

Advantageously the food product is an oil and water containing emulsion, for instance a spread. Oil and water emulsion is herein defined as an emulsion comprising oil and water and includes oil in water (O/W) emulsions and water in oil emulsions (W/O) and more complex emulsions for instance water-in-oil-in-water (W/O/W/O/W) emulsions. Oil is herein defined as including fat.

Preferably the food product is a spread, frozen confection, or sauce.

Preferably a spread according to the invention comprises 30-90 wt. % vegetable oil. Advantageously a spread has a pH of 4.2-6.0.

The invention further relates to a food product comprising an amount of 0.003 mg/g protein, of a peptide or peptide salt comprising the peptide sequence Asp-Lys and/or Ile-His-Pro-Phe.

Preferably the peptide comprises the peptide sequence Asp-Lys-Ile-His-Pro-Phe (SEQ ID No: 1). Preferably, the peptide or peptide salt has 2-15 amino acids.

The invention further relates to a food product comprising an amount of 0.003 mg/g protein, or more, of the peptide Val-Pro, and/or one or more 2-15 amino acid peptides or peptide salts comprising a peptide sequence selected from the group consisting of Val-Leu-Pro, Leu-Pro-Val-Pro, Leu-Pro-Val, Leu-Pro and/or Lys-Val-Leu-Pro-Val-Pro, Lys-Val-Leu-Pro-Val-Pro-Gln. More preferably the peptide or peptide salt is a 6-15 amino acid peptide or peptide salt comprising the peptide sequence Lys-Val-Leu-Pro-Val-Pro (SEQ ID No: 2). Preferably, the 6-15 amino acid peptide or peptide salt comprising the peptide sequence Lys-Val-Leu-Pro-Val-Pro-Gln (SEQ ID No: 3). Advantageously the food product comprises an amount of 0.006 mg/g protein, or more, of the above peptides, more preferably more than 0.01 mg/g protein. Such an amount gives an improved blood pressure lowering effect in humans.

Preferably the food product according to the invention comprises an amount of 0.003 mg/g protein of a peptide or peptide salt comprising the peptide sequence Asp-Lys and/or Ile-His-Pro-Phe and amount of 0.003 mg/g protein, or more, of a 6-15 amino acid peptide or peptide salt comprising the peptide sequence Lys-Val-Leu-Pro-Val-Pro (SEQ ID No: 2)

The food product may be produced according to the invention from milk fermented with Lactobacillus delbrueckii subsp. lactis. Preferably the milk is fermented with Lactobacillus delbruecki susbsp. lactis 05-14, since such milk has a relatively high pH and gives a high blood pressure lowering effect.

The strain Lactobacillus delbruecki susbsp. lactis 05-14 was deposited at the Centraal Bureau voor Schimmelculturen (CBS), Netherlands, on 26.01.2001 and has number CBS 109270. The strain was characterized by an API50CHL strip. The strain was able to ferment D-glucose, D-fructose, D-mannose, N-acetyl glucosamine, maltose, lactose, sucrose and trehalose. According to the APILAB Plus databank (version 5.0) it was subsequently identified as Lactobacillus delbrueckii subsp. lactis. The API50CHL strip and databank are available from bioMerieux SA, 69280 Marcy-l'Etoile, France.

The strain Lactobacillus delbrueckii subsp. lactis 05-14 was isolated from a commercial yoghurt culture 05-14 as described herein in the examples. The commercial yoghurt culture 05-14 was deposited at the Centraal Bureau voor Schimmelculturen (CBS), Netherlands, on Feb. 28, 2001 and has number CBS 109295.

The fact that a food product has been produced with Lb. delbrueckii subsp. lactis may be detected in the food product using analytical techniques available to the person skilled in the art. Non-limitative examples of such technique's are as follows. When live Lb. delbrueckii subsp. lactis is still present in the food product, a taxonomic analysis of the microorganism may be executed.

Alternatively the DNA of Lb. delbrueckii subsp. lactis may be detected in the food product.

Still alternatively, the presence of substances which are produced by Lb. delbrueckii subsp. lactis may be detected. An example is measuring the amount of D-lactic acid in the food product, relative to the total amount of lactic acid (D- and L-lactic acid). In fermented milk fermented with Lb. delbrueckii subsp. lactis., the amount of D-lactic acid is 100% and L-lactic acid is absent. This contrasts with a usual yoghurt which is the fermentation product of a mixed culture comprising Lb. delbruecki subsp. bulgaricus and Streptococcus thermophilus, in which L- and D-lactic acid is present.

### EXAMPLES

### Explanation of the figures

FIG. 1

FIG. 1 gives the acute effect of fermented milks of example 1 (symbol X) and milk fermented with Lactobacillus helveticus (ex. Calpis, symbol ∘) compared to the placebo milk (symbol Δ) on systolic blood pressure (SBP) over 8 hours (n=35).

Values represent means and standard error (SE). The X-axis represents time (hours) and the Y-axis represents systolic blood pressure (mmHg).

FIG. 2

FIG. 2 gives the acute effect of fermented milks of example 1 (symbol X) and milk fermented with Lactobacillus helveticus (Calpis, symbol ∘) compared to the placebo milk (symbol Δ) on diastolic blood pressure (DBP) over 8 hours (n=35).

Values represent means and standard error (SE). The X-axis represents time (hours) and the Y-axis represents diastolic blood pressure (mmHg).

FIG. 3

FIG. 3 shows the activity profile of HPLC fractions of milk fermented with Lactobacillus delbruecki subsp. Lactis 05-14. Values on the vertical axis (Y-axis) represent ACE inhibition (%), on the horizontal axis HPLC fractions are given (numbered). FIG. 3 shows that fractions 58 and 59 show the highest ACEI values.

### Determination of ACE Inhibition Activity

For the determination of the angiotensin I-converting enzyme (ACE) inhibition activity of the fermented milks, the whey fraction of the fermented milks was used. The whey fraction was obtained as follows. The pH of the fermented milk was first adjusted to 3.4 by addition of 3 M HCl . Subsequently, the milk was centrifuged at 4000 ×g for 10 min. 2 M NaOH was added to the supernatant to raise the pH to 8.3 and then the solution was centrifuged at 15.000 ×g for 10 minutes. The final supernatant was used as the whey fraction to determine the ACE inhibition activity.

The ACE inhibition activity was assayed according to the method 15 of Matsui et al. (Matsui, T. et al. (1992) Biosci. Biotech. Biochem. 56: 517-518) with the modifications described below.

TABLE 1
procedure for ACE inhibition assay. The components
were added in a 1.5-ml tube with a final volume of 120 μl.

| | Control 1 | | Sample 1 | Sample 2 |
|---|---|---|---|---|
| Component | (μl) | Control 2 (μl) | (μl) | (μl) |
| HHL (3 mM) | 75 | 75 | 75 | 75 |
| H₂O | 25 | 45 | — | 20 |
| Sample/inhibit | — | — | 25 | 25 |
| or | | | | |
| ACE (0.1 U/ml) | 20 | — | 20 | — |

For each sample 75 μl 3 mM hippuryl histidine leucine (Hip-His-Leu, Sigma chemicals Co.; the chemical was dissolved in 250 mM Borate containing 200 mM NaCl, pH 8.3); 20 μl 0.1 U/ml ACE (obtained at Sigma) or H₂ O, and 25 μl sample or H₂O were mixed (see Table 1). The mixtures were incubated at 37° C. and stopped after 30 min by adding 125 μl 0.5 M HCl. Subsequently, 225 μl bicine/NaOH solution (1 M NaOH : 0.25 M bicine (4:6)) was added, followed by 25 pl 0.1 M TNBS (2,4,6-Trinitrobenzenesulfonic acid, Fluka, Switzerland; in 0.1 M Na₂HPO₄). After incubation for 20 min. at 37° C., 4 ml 4 mM Na₂SO₃ in 0.2 M NaH₂PO₄ was added and the absorbance at 416 nm was measured with UV/Vis spectrophotometer (Shimadzu UV-1601 with a CPS controller, Netherlands). The amount of ACE inhibition (ACEI) activity was calculated as a percentage of inhibition compared with the conversion rate of ACE in the absence of an inhibitor:
ACEI (%) (((C1-C2)-(S1-S2))/(C1-C2))*100 (1)
wherein
C1=Absorbance without ACE inhibitory component (=max. ACE activity) [AU].
C2=Absorbance without ACE inhibitory component and without ACE (background) [AU].
S1=Absorbance in the presence of ACE and the ACE inhibitory component [AU].
S2=Absorbance in the presence of the ACE inhibitory component, but without ACE [AU].

### Example 1 and Comparative Examples A to U

a) Fermentation with Lactic Acid Bacteria

Each of the micro-organisms of examples 1-3 and comparative examples A to S, mentioned in table 2, was cultured in 10-ml sterile skimmed milk by inoculation with 2% of a culture that has been stored at −80° C. as a full grown culture in skimmed milk, diluted with sterile 10% glycerol to an end volume of 6% glycerol. The cultures with a Lb. delbrueckii or a Lb. helveticus strain were incubated in skimmed milk (Yopper ex Campina, Netherlands) for 24 hours at 37° C., while the culture with the Lactococcus lactis strain, was incubated at 30° C. for 24 h. After finishing the fermentation the pH and the ACE inhibition activity of the whey fraction were measured. Table 2 gives an overview of the different lactic acid bacteria used, the resulting pH and the ACE inhibition activity (ACEI).

TABLE 2
Angiotensin I-converting enzyme (ACE) inhibition
activity (ACEI) of whey fractions of examples 1, A-U.

| Example | Micro-organism | pH | ACEI (%) |
|---|---|---|---|
| 1 | Lb. delbrueckii subsp. | 5.2 | 47 |
| | lactis 05-14 | | |
| A | Lb. delbrueckii subsp. | 3.9 | 14 |
| | lactis ATCC 12315 | | |
| B | Lb. delbrueckii subsp. | 4.3 | −43 |
| | bulgaricus YB1 | | |
| C | Lb. delbrueckii subsp. | 4.5 | −1 |
| | bulgaricus 13a | | |
| D | Lb. delbrueckii subsp. | 4.2 | 6 |
| | bulgaricus Y5a | | |
| E | Lb. delbrueckii subsp. | 4.0 | 2 |
| | bulgaricus CH3 | | |
| F | Lb. delbrueckii subsp. | 4.1 | 37 |
| | bulgaricus Fargo 404 | | |
| G | Lb. delbrueckii subsp. | 4.1 | −7 |
| | bulgaricus LB291 | | |
| H | Lb. delbrueckii subsp. | 4.1 | 8 |
| | bulgaricus NIZO RR | | |
| I | Lb. delbrueckii subsp. | 4.5 | 14 |
| | bulgaricus Wiesby 231 | | |
| J | Lb. delbrueckii subsp. | 4.3 | 9 |
| | bulgaricus Wiesby 709 | | |
| K | Lb. delbrueckii subsp. | 4.0 | 20 |
| | bulgaricus Wiesby V1 | | |
| L | Lb. delbrueckii subsp. | 4.2 | −3 |
| | bulgaricus Wiesby 4 | | |
| M | Lb. helveticus 7 | 3.6 | 54 |
| N | Lb. helveticus CNRZ 32 | 3.6 | 30 |
| O | Lb. helveticus 303 | 3.8 | 75 |
| P | Lb. helveticus ATCC 15009 | 3.6 | 69 |
| Q | Lb. helveticus CNRZ 244 | 4.0 | 70 |
| R | Lb. helveticus NCDO 766 | 3.6 | 64 |
| S | Lb. helveticus ATCC 55796 | 4.0 | 42 |
| T | Milk fermented with Lb. | 3.7 | 60 |
| | Helveticus (ex. Calpis) | | |
| U | Lactococcus Lactis subsp. | 4.3 | 37 |
| | Cremoris C2 | | |

The results show that in general, Lb. helveticus and Lb. delbrueckii subsp. lactis strains have a higher ACE inhibition activity than the Lactococcus lactis subsp. cremoris C2 and Lb. delbrueckii subsp. bulgaricus strains. The pH after 24 h is for the Lb. helveticus much lower than for the Lb. delbrueckii subsp. bulgaricus- and Lactobacillus delbrueckii subsp. lactis strains.

The ACE inhibition activity of the Lb. delbrueckii subsp. bulgaricus strains in general showed almost no or low ACE inhibition activity, except for the Lb. delbrueckii subsp. bulgaricus Fargo 404, which showed reasonable good inhibition.

The Lb. delbrueckii subsp. lactis strain of example 1 showed good ACE inhibition, similar as the Lactobacillus helveticus strains, but the pH after 24 hours is higher and therefore the milk has a less acidic taste. The Lb. delbrueckii subsp. lactis used in example 1, according to the invention, is a Lb. delbrueckii subsp. lactis, that after 24 hours of fermentation at 37° C. in skimmed milk (Yopper ex Campina, Netherlands) gives a pH of the fermented milk of 5.2.

The Lb. delbrueckii subsp. lactis used in comparative example A, is a Lb. delbrueckii subsp. lactis, that after 24 hours of fermentation at 37° C. in skimmed milk (Yopper ex Campina, Netherlands) gives a pH of the fermented milk of 3.9. Comparative example A did not show good ACE inhibition activity.

b) Comparison of Lb. 05-14 and the Yoghurt Culture from Which Lb. 05-14 was isolated

Lb. delbrueckii subsp. lactis 05-14 has been isolated from a yoghurt culture, deposited under CBS 109295, containing besides this strain, also a Streptococcus thermophilus and a Lb. delbrueckii subsp. bulgaricus. The ACE inhibition activity of the Lb. delbrueckii subsp. lactis 05-14 was compared to the ACE inhibition activity of the whole yoghurt culture and the Streptococcus thermophilus 05-14. All three cultures were grown for 24 h in skimmed milk (Yopper ex Campina, Netherlands) at 37° C. The percentage of respectively D- and L-lactic acid formed was determined.

TABLE 3
Comparison of Lb. 05-14 and the yoghurt culture from
which Lb. 05-14 was isolated

| Strain | pH | ACEI % | D-Lactate % | L-Lactate % |
|---|---|---|---|---|
| Lb. lactis 05-14 | 5.17 | 46 | 100 | 0 |
| Streptococcus | 4.59 | −6 | 0 | 100 |
| thermophilus 05-14 | | | | |
| Yoghurt 05-14 | 4.12 | 10 | 85 | 15 |

From these results it can be concluded that Lb. delbrueckii subsp. lactis 05-14 is the main ACE- inhibiting culture in the yoghurt. The fact that some ACE inhibiting activity (10%) of the yoghurt mixture is found can be explained by the fact that after 24 hours of fermentation time, the largest number of microorganisms is formed by the Lactobacillus species. This can be concluded from the relative amount of D-lactate formed in the milk fermented with the yoghurt mixture (85%). D-lactate is only produced by the Lactobacillus species in the yoghurt mixture.

c) Human Intervention Study

A human intervention study was done to investigate the ability of a single dose of milk produced by fermentation to acutely lower blood pressure compared to a placebo in high normal or mild hypertensive individuals. The fermented milk of example 1 and a commercial fermented milk Calpis (Calpis, Japan) (example S) were tested. The placebo was milk acidified to a pH of 3.7 with lactic acid.

The human intervention study was a double blind cross-over design to investigate the fermented milk of example 1 and commercial product Calpis (Calpis, Japan) compared to a placebo on the blood pressure (measured as SBP and DBP) in normotensive individuals with slightly high blood pressure and mild hypertensive individuals over an 8 hour period.

Subjects were selected with a systolic blood pressure (SBP) between 135-159 mm Hg and DBP between 85-99 mm Hg, BMI≧18 ≦32 kg/m2, age ≧35 ≦70 years, healthy and no reported current or previous metabolic disease, chronic gastrointestinal disorders, or cardiovascular disease. Other inclusion criteria included not consuming a medical or slimming diet, no blood donation within the last two months, not exercising intensively, not consuming excessive alcohol and not smoking greater than 15 cigarettes per day.

Blood pressure measurements were taken using calibrated Omron IC blood pressure monitor after rest for about 15 minutes. Three blood pressure measurements were made at each time point and the mean of the second two blood pressure readings used. During screening the subject had blood pressure levels measured on two separate occasions to try to eliminate the ‘white coat effect’which may lead to the recruitment of subjects with blood pressure outside the required levels. Once recruited the subjects were asked to give informed consent and then they were randomly assigned to receive each of the treatments or the placebo in random-order.

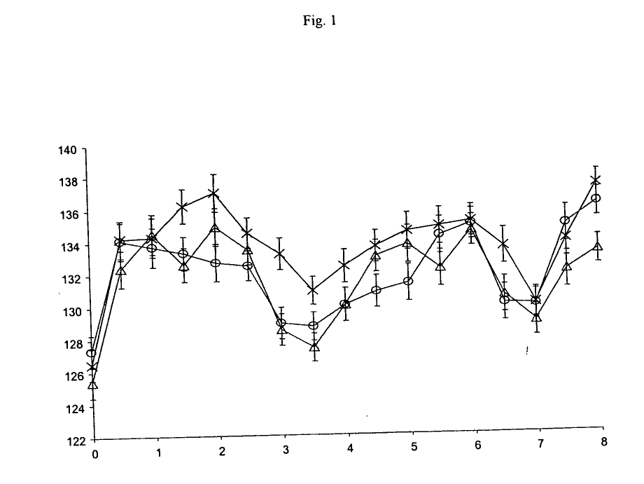

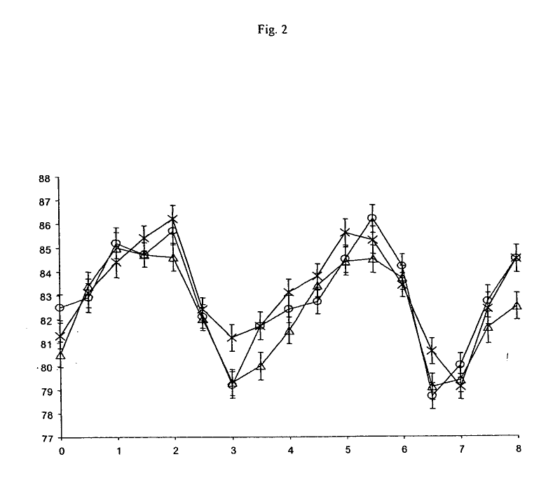

During the study days the subject arrived in the human investigation unit in a fasted state (fasting from 12 am the previous night) at about 7 am. Initially the subjects had their fasted blood pressure measured. This was taken twice. Blood pressure was measured every half an hour for 8 hours throughout the day. Subjects were given one dose of 160 ml of either one of the treatments or the placebo at 0 hours. This was followed by breakfast at 2 hours and lunch at 6 hours. These times refer to the time-axis in FIGS. 1 and 2. Subjects were provided with food that they normally consumed through out the day and were allowed to consume a caffeinated drink at breakfast and lunch. This food and drinking pattern was repeated on each study day. Other fermented foods such as yoghurt, fermented meat, and cheese were not allowed during the study day.

Two hundred subjects were screened and out of this thirty-six subjects meet the inclusion criteria and were invited to join the study. All the subjects took part in the study and one drop out occurred during the study. The baseline characteristics of the subjects are given in Table 4. The SBP and DBP were lower at baseline than at the second screening.

FIGS. 1 and 2 give the mean (SE), SBP and DBP response of the subjects to the 2 different treatments and the placebo over the 8 hours. The fermented milk of example 1 produced a significantly lower SBP than the control treatment at 2, 3 and 6 hours (4.3, 4.3 and 3.5 mm Hg respectively, P<0.05) after consumption and a significantly lower DBP after 3 and 6.5 hours (2.0 and 1.9 mm Hg respectively, P<0.05). The commercial product Calpis produced a significantly lower SBP than the control treatment at 1.5, 3, 3.5 and 8 hours (3.6, 4.7, 3.5 and 2.9 mm Hg respectively, P<0.05) after consumption and a significantly lower DBP after 3 and 8 hours (1.9 and 2 mm Hg respectively, P<0.05).

TABLE 4
The characteristics of the subjects of the human
intervention study at baseline, mean and standard deviation
(SD) between brackets

| | | Females | |
|---|---|---|---|
| | Males (n = 12) | (n = 24) | Total (n = 36) |
| Age (Y) | 58.3 (10.7) | 57 (7.1) | 57.4 (8.3) |
| BMI (kg/m²) | 24.7 (2.3) | 27.7 (2.3) | 26.7 (2.7) |
| Initial SBP* | 132 (12) | 127 (11) | 128 (12) |
| (mm Hg) | | | |
| Initial DBP* | 85 (7) | 81 (6) | 83 (7) |
| (mm Hg) | | | |

*Baseline blood pressure on first test day

d) HPLC Separation of Milk Fermented with Lactobaccillus Delbrueckii Subsp. Lactis 05-14

The whey fraction of milk fermented with Lactobaccillus delbrueckii subsp. lactis 05-14, was adjusted to pH 3.4 by the addition of 3 N HCl, coagulated proteins were centrifuged down at 4000 g for 10 min., the supernatant was brought to pH 8.3 with 2 N NaOH and the precipitate was centrifuged down again as described. A volume of 500 μl of the supernatant was injected on a Chrompack Inertsil ODS-2 column using a Shimadzu SIL-10 ADvp auto-injector. Sixtyfour fractions of 0.5 ml were collected using an Isco Foxy Jr fraction collector. This procedure was repeated four times to increase the amount of peptides per fraction. The elution of the mobile phase was regulated with a Spectra Physics P4000 HPLC pump using the following elution gradient:

| Time (min) | Gradient |
|---|---|
| 0 | 100% A |
| 5 | 100% A |
| 15 | 95% A/5% B |
| 30 | 70% A/30% B |
| 50 | 50% A/50% B |
| 55 | 100% A |
| 60 | 100% A |

Where A is 0.1% TFA in water and B is 0.1% TFA in acetonitrile.

The signal was detected using a Waters 484 UV-detector at 215 nm. After collecting the fractions were kept refrigerated at 4° C. subsequently freeze-dried.

e) Measurement of the Activity of Fermented Milk HPLC-Fractions

The measurements were carried out on an HPLC-MS combination existing of a HP1100 HPLC (Hewlett Packard) and a Quattro-II triple quadrupole mass spectrometer (Micromass).

The ACE inhibition assay as described herein (examples 1 to 3 and A to T was applied to 100 μL of each HPLC-fraction, but the ACE activity was measured by determining the conversion of Hip-His-Leu (HHL) into Hip (H) and His-Leu (HL) by HPLC-MS as follows. Samples were taken at t=0 minutes and at t =60 minutes reaction time and stored at −20 ° C. 100 μL of the reaction mixture was injected on a 150 ×4.6 mm Inertsil 5 ODS 2 column with a particle size of 5 μm (ex Chrompack). The gradient program is given below.
Solvent A 100% Milli-Q water+0.1% Trifluro acetic acid (TFA)

Solvent B gradient grade acetonitrile (Merck)+0.1% TFA

TABLE 5
Gradient profile

| Time (min) | % A | % B |
|---|---|---|
| 0 | 100 | 0 |
| 5 | 100 | 0 |
| 15 | 95 | 5 |
| 30 | 70 | 30 |
| 50 | 50 | 50 |
| 60 | 100 | 0 |

The ionization mode used was positive electrospray (ESI). The capillary voltage was 4 kV and the cone voltage was 37 V for HHL and 55 V for HL.

Quantification of HHL and H was carried out from the UV trace at 280 nm, and from the mass-traces at 269.1 Da for HL and at 430.1 Da for HHL in Single Ion Recording (SIR). The percentage inhibition was calculated for each analyte trace according to the following equation:

$$\frac{( ( {Aref}_{t0} - {Aref}_{t60} ) - ( {Asmpl}_{t0} - {Asmpl}_{t60} ) ) \times 100}{( ( {Aref}_{t0} - {Aref}_{t60} )} \qquad ( 2 )$$

In which:
Arefₜ₀=the peak area of the analyte in the reference sample without inhibitor taken at 0 minutes.
Arefₜ₆₀the peak area of the analyte in the reference sample without inhibitor taken at 60 minutes.
Asmplₜ₀ =the peak area of the analyte in the sample with inhibitor taken at 0 minutes.
Asmplₜ₆₀the peak area of the analyte in the sample with inhibitor taken at 60 minutes.

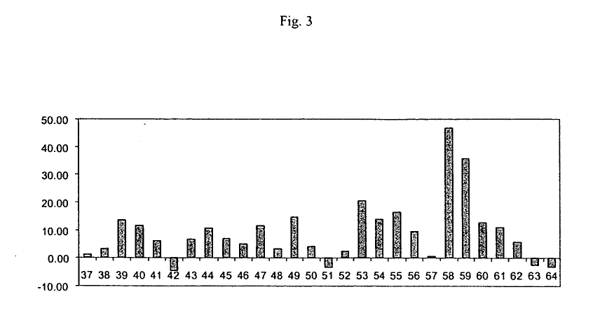

The percentage inhibition was calculated for HHL from both the UV trace and the MS trace, for HL from the MS trace and for H from the UV trace. The averaged percentage inhibition for each HPLC fraction was calculated from these four values. The highest activity in the HPLC samples of Lactobacillus lactis 05-14 was found in HPLC fraction 58. The activity profile is given in FIG. 3. Fractions 53-55 gave the second best activities.

f) Determination of molecular ions of active peptides

The HPLC fractions were analyzed with the mass spectrometer in full scanning mode using flow injection analysis. 20 μL of each HPLC fraction was injected subsequently in the eluent flow with an interval of two minutes. The eluent flow existed of acetonitrile/water 1/1 with a flow rate of 50 μL/min. The mass spectrometer was in full scanning mode with a scan range of 100 Da - 1400 Da at a scan speed of 3 seconds per scan. In the spectrum of fraction 58, two dominating ions could be observed, m/z 378.8 and m/z 756.3 representing the doubly charged and singly charged ions of a species with a molecular ion of approximately 755.3 Da. The MS trace profile of these ions fitted well with the profile of the activity measurement in FIG. 3.

The spectrum of fraction 55, another fraction with increased ACEI activity, showed a complex spectrum, the MS trace of one of these ions, m/z 780.5 fitted well with the profile of the activity measurement in FIG. 3 and was used for further analysis.

g) Identification of the active peptides

The exact molecular mass of the active peptide in fraction 58 was determined at 755.40 Da. Daughter ion MS-MS was carried out on the doubly charged ion m/z 378.8. The collision energy used was 22 keV and the collision pressure in the gas cell was 1.7 10⁻³ mbar, the collision gas was argon. The combination of the molecular mass and the daughter spectrum indicated that the peptide sequence was Asp-Lys-Ile-His-Pro-Phe, residue 47-52 of β-casein with a theoretical molecular mass of 755.40.

The measured molecular mass of the ion of interest in fraction 55 was 780.46 Da representing a peptide with a molecular mass of 779.46 Da. Daughter ion MS-MS was performed on this ion using the conditions described previously. The ion was identified as Lys-Val-Leu-Pro-Val-Pro-Gln, residue 169 - 175 of β-casein with a theoretical molecular mass of 779.49. The deviation between the measured and theoretical molecular mass was within the accuracy of the instrument used. Both peptides were synthesized and analyzed using daughter ion MS-MS. The resulting spectra were identical to those of the active fractions. Another peptide of interest, Lys-Val-Leu-Pro-Val-Pro residue 169 - 174 of of P-casein molecular mass 651.43 Da was also synthesized. The sequence was confirmed by daughter ion MS-MS.

h) Concentration of the active peptides

The concentration of the active peptides in fermented milk was determined by using a standard addition flow injection MRM method. With this method standard additions of the synthesized peptides to the fermented milk were performed and measured with mass spectrometry. Typical measured concentrations are given in table 6.

TABLE 6
Concentrations of active peptides in fermented milk

| | Sequence | |
|---|---|---|
| | listing | Concentration |
| Peptide | no. | in mg/l |
| Asp-Lys-Ile-His-Pro- | 1 | 1.8 |
| Phe | | |
| Lys-Val-Leu-Pro-Val- | 2 | 0.9 |
| Pro-Gln | | |
| Lys-Val-Leu-Pro-Val- | 3 | 0.1 |
| Pro | | |

i) Synthesis of active peptides

The peptides given in tables 6 and 7 were synthesized using standard Fmoc chemistry on Wang resin or 2-Chlorotrityl resin with a 433A peptide synthesizer (Applied Biosystems). Fmoc-protected amino acids with acid-labile side-chain protected groups were activated with 2-(1H-benzotriazol-1-yl)-1,1,3,3,-tetramethyluronium hexafluorophosphate (HBTU) in n-methyl-2-pyrrolidone (NMP) in the presence of diisopropylethylamine prior to the addition to the resin. After synthesis the peptide was deprotected in the presence of scavengers and cleaved off from the resin by trifluoroacetic acid (TFA). Purification was achieved using C18 reversed-phase HPLC. The peptides were analyzed by analytical HPLC and TLC.

The ACE-inhibition of peptides that were synthesised, were measured and the result are given in table 7.

TABLE 7
ACE inhibition (IC50) of synthesized peptides

| | Sequence | |
|---|---|---|
| Peptide | number | IC50 (μM) |
| KVLPVPQ | 3 | 1000 |
| KVLPVP | 2 | 5 |
| VLP | 4 | 120 |
| LPVP | 5 | 250 |
| LPV | 6 | >1000 |
| LP | 7 | >1000 |

1-5. (cancelled)

6. Food product comprising whey, characterized in that the whey is produced from milk fermented with Lactobacillus delbrueckii subsp. lactis.

7. Food product according to claim 6, wherein the food product is an oil and water containing emulsion.

8. Food product according to claim 7, wherein the food product is a spread, frozen confection, or sauce.

9. Food product according to claim 8, wherein the food product is a frozen confection, comprising 0 to 20 wt. % of fat, 0 to 20 wt. % of sweeteners, 2 to 20 wt.% of non-fat milk components and optional components such as emulsifiers, stabilizers, preservatives, flavouring ingredients, vitamins, minerals, the balance being water.

10. Food product according to claim 9, wherein the food product is a spread comprising 30-90 wt. % vegetable oil.

11. Food product according to claim 10, wherein the pH of the spread is 4.2-6.0.

12. Food product according to claim 6, wherein the Lactobacillus delbrueckii susbsp. lactis is Lactobacillus delbrueckii susbsp. lactis 05-14, deposited at the Centraal Bureau voor Schimmelculturen on 26 Jan. 01, 2001 having no. CBS 109270.

13. Food product comprising an amount of 0.003 mg/g protein, or more, of a peptide or peptide salt having 2-15 amino acids, comprising the peptide sequence Asp-Lys and/or Ile-His-Pro-Phe.

14. Food product according to claim 13, comprising an amount of 0.003 mg/g protein, or more, of the peptide Val-Pro, and/or 0.003 mg/g protein, or more, of one or more peptides or peptide salts having 2-15 amino acids, comprising a peptide sequence selected from the group consisting of Val-Leu-Pro, Leu-Pro-Val-Pro, Leu-Pro-Val, Leu-Pro, Lys-Val-Leu-Pro-Val-Pro, and Lys-Val-Leu-Pro-Val-Pro-Gln.

15. Food product according to claim 13, wherein the amount of peptide or peptide salt is 0.01 mg/g protein, or more.

16. Food product according to claim 13, comprising a 6-10 amino acid peptide or peptide salt comprising the peptide sequence Lys-Val-Leu-Pro-Val-Pro.

17. Food product according to claim 16, wherein the 6-10 amino acid peptide or peptide salt comprises the peptide sequence Lys-Val-Leu-Pro-Val-Pro-Gln.

18. Food product according to claim 13, wherein the peptide or peptide salt comprises the peptide sequence Asp-Lys-Ile-His-Pro-Phe.

19. Food product according to claim 13, wherein the food product is produced from milk fermented with Lactobacillus delbrueckii subsp. lactis.
